(19) United States
(12) Patent Application Publication
(10) Pub. No.: US 2026/0223067 A1
(43) Pub. Date: Jul. 30, 2026

(54) TECHNIQUES FOR PAGING CONFIGURATION

(71) Applicant: QUALCOMM Incorporated, San Diego, CA (US)

(72) Inventors: Le LIU, San Jose, CA (US); Alberto RICO ALVARINO, San Diego, CA (US); Yan ZHOU, San Diego, CA (US); Chiranjib SAHA, Lakeside, CA (US)

(21) Appl. No.: 19/039,554

(22) Filed: Jan. 28, 2025

(51) Int. Cl. H04W 68/00; H04W 52/02

(52) U.S. Cl. CPC H04W 68/00; H04W 52/0212

(57) ABSTRACT

Methods, systems, and devices for wireless communications are described. In some examples, a user equipment (UE) may receive configuration information that indicates one or more first paging bandwidth parts (BWPs) associated with a first device type and one or more second paging BWPs associated with a second device type. The UE may monitor for a paging message associated with the one or more first paging BWPs or the one or more second BWPs based on a device type of the UE, wherein the device type is the based on device capabilities. In some cases, the UE may receive a first physical downlink control channel (PDCCH) monitoring configuration associated with the first device type, a second PDCCH monitoring configuration associated with the second device type, or a combination thereof.

### FIELD OF TECHNOLOGY

The following relates to wireless communications, including techniques for paging configuration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information that indicates one or more first paging bandwidth parts (BWPs) associated with a first device type and one or more second paging BWPs associated with a second device type and monitoring for a paging message associated with the one or more first paging BWPs or the one or more second paging BWPs based on a device type of the UE, where the device type is based on device capabilities.

A UE for wireless communications is described. The UE may include one or more memories storing processor executable code, and one or more processors coupled with the one or more memories. The one or more processors may individually or collectively be operable to execute the code to cause the UE to receive configuration information that indicates one or more first paging BWPs associated with a first device type and one or more second paging BWPs associated with a second device type and monitor for a paging message associated with the one or more first paging BWPs or the one or more second paging BWPs based on a device type of the UE, where the device type is based on device capabilities.

Another UE for wireless communications is described. The UE may include means for receiving configuration information that indicates one or more first paging BWPs associated with a first device type and one or more second paging BWPs associated with a second device type and means for monitoring for a paging message associated with the one or more first paging BWPs or the one or more second paging BWPs based on a device type of the UE, where the device type is based on device capabilities.

A non-transitory computer-readable medium storing code for wireless communications is described. The code may include instructions executable by one or more processors to receive configuration information that indicates one or more first paging BWPs associated with a first device type and one or more second paging BWPs associated with a second device type and monitor for a paging message associated with the one or more first paging BWPs or the one or more second paging BWPs based on a device type of the UE, where the device type is based on device capabilities.

In some examples of the method, user equipment (UEs), and non-transitory computer-readable medium described herein, receiving the configuration information may include operations, features, means, or instructions for receiving a system information block (SIB) that indicates an initial BWP used as one paging BWP and additional configuration of the one or more first paging BWPs associated with the first device type.

In some examples of the method, user equipment (UEs), and non-transitory computer-readable medium described herein, receiving the configuration information may include operations, features, means, or instructions for receiving an SIB that indicates one or more initial BWPs used as the one or more first paging BWPs associated with the first device type.

In some examples of the method, user equipment (UEs), and non-transitory computer-readable medium described herein, receiving the configuration information may include operations, features, means, or instructions for receiving a first physical downlink control channel (PDCCH) monitoring configuration associated with the first device type, a second PDCCH monitoring configuration associated with the second device type, or a combination thereof and monitoring for a PDCCH message associated with the first PDCCH monitoring configuration or the second PDCCH monitoring configuration based on the device type of the UE.

In some examples of the method, user equipment (UEs), and non-transitory computer-readable medium described herein, receiving the configuration information may include operations, features, means, or instructions for receiving a PDCCH monitoring configuration associated with the second device type and monitoring for a PDCCH message associated with the PDCCH monitoring configuration or associated with a lowest coverage level of the PDCCH monitoring configuration, where the device type of the UE may be the first device type.

In some examples of the method, user equipment (UEs), and non-transitory computer-readable medium described herein, receiving the configuration information may include operations, features, means, or instructions for receiving a PDCCH repetition number associated with a device type and determining a physical downlink shared channel (PDSCH) repetition number or a physical uplink shared channel (PUSCH) repetition number based on the PDCCH repetition number, where a PDSCH or a PUSCH may be scheduled by a PDCCH for a same device type of the UE.

In some examples of the method, user equipment (UEs), and non-transitory computer-readable medium described herein, receiving the configuration information may include operations, features, means, or instructions for receiving a first synchronization signal configuration associated with the first device type, a second synchronization signal configuration associated with the second device type, or a combination thereof, where the first synchronization signal configuration indicates a one or more first synchronization signals associated with the one or more first paging BWPs and the second synchronization signal configuration indicates a one or more second synchronization signals associated with the one or more second paging BWPs and monitoring for the one or more first synchronization signals associated with the first synchronization signal configuration or the one or more second synchronization signals associated the second synchronization signal configuration based on the device type of the UE.

In some examples of the method, user equipment (UEs), and non-transitory computer-readable medium described herein, receiving the configuration information may include operations, features, means, or instructions for receiving a wake-up signal configuration with a first wake-up signal group associated with the first device type, a second wake-up signal group associated with the second device type, or a combination thereof and monitoring for one or more wake-up signals associated with the first wake-up signal group or the second wake-up signal group based on the device type of the UE.

In some examples of the method, user equipment (UEs), and non-transitory computer-readable medium described herein, receiving the configuration information may include operations, features, means, or instructions for receiving a first wake-up signal configuration associated with the one or more first paging BWPs and a second wake-up signal configuration associated the one or more second paging BWPs and monitoring for one or more first wake-up signals associated with the first wake-up signal configuration or one or more second wake-up signal signals associated the second wake-up signal configuration based on the device type of the UE.

In some examples of the method, user equipment (UEs), and non-transitory computer-readable medium described herein, receiving the configuration information may include operations, features, means, or instructions for receiving a paging early indication (PEI) configuration with first PEI messages associated with the first device type, second PEI messages associated with the second device type, or a combination thereof and monitoring for first PEI messages or the second PEI messages based on the device type of the UE.

In some examples of the method, user equipment (UEs), and non-transitory computer-readable medium described herein, receiving the configuration information may include operations, features, means, or instructions for receiving a first paging early indication (PEI) configuration associated with the one or more first paging BWPs and a second PEI configuration associated the one or more second paging BWPs and monitoring for one or more first PEI messages associated with the first PEI configuration or one or more second PEI messages associated the second PEI configuration based on the device type of the UE.

In some examples of the method, user equipment (UEs), and non-transitory computer-readable medium described herein, receiving the configuration information may include operations, features, means, or instructions for receiving a first paging duty cycle configuration associated with the first device type, a second paging duty cycle configuration associated with the second device type, or a combination thereof and monitoring for the paging message based on the first paging duty cycle configuration or the second paging duty cycle configuration based on the device type of the UE.

In some examples of the method, user equipment (UEs), and non-transitory computer-readable medium described herein, receiving the configuration information may include operations, features, means, or instructions for receiving paging duty cycle configuration associated with the second device type and monitoring for the paging message associated with the paging duty cycle configuration or associated with a lowest coverage level of the paging duty cycle configuration, where the device type of the UE may be the first device type.

Some examples of the method, user equipment (UEs), and non-transitory computer-readable medium described herein may further include operations, features, means, or instructions for receiving a first paging downlink control information (DCI) associated with the first device type, where the first paging DCI having a first format different from a second format of a second paging DCI associated with the second device type.

In some examples of the method, user equipment (UEs), and non-transitory computer-readable medium described herein, the first format including one or more flag bits indicating a paging indication, a direction indications of a short message, or combination of both.

In some examples of the method, user equipment (UEs), and non-transitory computer-readable medium described herein, the first format including a short message that directly indicates an identification for different system information variations.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for paging configuration in accordance with one or more aspects of the present disclosure.

FIG. 2 shows an example of a wireless communications system that supports techniques for paging configuration in accordance with one or more aspects of the present disclosure.

FIG. 3 shows an example of a frequency diagram that supports techniques for paging configuration in accordance with one or more aspects of the present disclosure.

FIG. 4 shows an example of a process flow that supports techniques for paging configuration in accordance with one or more aspects of the present disclosure.

FIGS. 5 and 6 show block diagrams of devices that support techniques for paging configuration in accordance with one or more aspects of the present disclosure.

FIG. 7 shows a block diagram of a communications manager that supports techniques for paging configuration in accordance with one or more aspects of the present disclosure.

FIG. 8 shows a diagram of a system including a device that supports techniques for paging configuration in accordance with one or more aspects of the present disclosure.

FIGS. 9 and 10 show flowcharts illustrating methods that support techniques for paging configuration in accordance with one or more aspects of the present disclosure.

### DETAILED DESCRIPTION

In some wireless communications systems, a network entity may communicate with a variety of wireless communication devices, such as a user equipment (UE), an enhanced mobile broadband (eMBB) UE, an Internet of Things (IoT) wireless device (IoT UE), a low complexity IoT device, an enhanced RedCap (eRedCap) wireless device, a long term evolution (LTE) machine type communication (MTC) wireless device, and an LTE narrowband IoT (LTE NB-IOT) wireless device. In some examples, the network entity may support a low power wide area (LPWA) wireless communication technology to support the IoT wireless devices. The LPWA wireless devices (e.g., LPWA UEs) and the eMBB UEs (non-LPWA UEs) may share the same radio access technology (RAT). The network entity may transmit paging messages to the variety of wireless communication devices. The paging messages may be transmitted through scheduled transmissions on allocated resources (e.g., paging occasions) to inform an idle wireless device to wake up and monitor for information. In some cases, the network entity may support a large quantity of IoT UEs or LPWA UEs and a large quantity of eMBB UEs or non-LPPA UEs, and the network entity may support a large quantity of paging messages to the wireless devices. If the IoT UEs and the eMBB UEs share frequency resources for the paging messages, the IoT UEs and the eMBB UEs may be frequently awakened by detecting frequent paging messages on the shared frequency resources.

Techniques for paging configuration may be employed. In some examples, separate paging bandwidth parts (BWPs) may be configured for a first device type (e.g., LPWA UEs) and a second device type (e.g., non-LPWA UEs). For example, the UE may receive configuration information that indicates one or more first paging BWPs associated with the first device type and one or more second paging BWPs associated with a second device type. The UE may monitor for a paging message associated with the one or more first paging BWPs or the one or more second BWPs based on a device type of the UE, and the device type may be based on device capabilities. In some cases, separate physical downlink control channel (PDCCH) monitoring configurations may be configured for the first device type and the second device type. Separate synchronization signals may be configured in the paging BWP for first device type and the second device type. Separate wake-up signal (WUS) configurations and separate paging early indication (PEI) configurations may be configured in the paging BWP for the first device type and the second device type. A same or different paging duty cycle may be configured for the first device type and the second device type. A paging downlink control information (DCI) format may be different for first device type as compared to the paging DCI of the second device type.

Aspects of the disclosure are initially described in the context of wireless communications systems. Aspects of the disclosure are further illustrated by and described with reference to a frequency diagram, a process flow, apparatus diagrams, system diagrams, and flowcharts that relate to techniques for paging configuration.

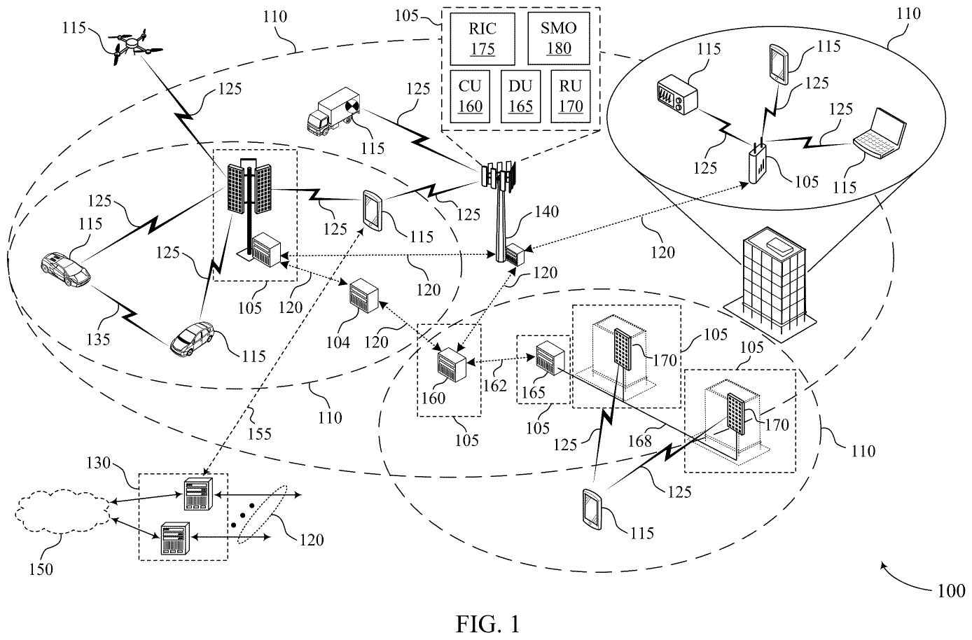

FIG. 1 shows an example of a wireless communications system 100 that supports techniques for paging configuration in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for paging configuration as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the UE 115 may be an enhanced RedCap (eRedCap) wireless device. For 5G NR, a separate initial downlink or uplink BWP may be configured for paging for the eRedCap wireless device in a system information block (SIB). If a separate initial downlink or uplink BWP for (e) Redcap UEs does not include CORESETO or cell defined synchronous signal block (CD-SSB), the initial BWP may be used for random access, but the initial BWP may not be used for paging messages. For the case with the separate initial downlink or uplink BWP that does not include CORESETO or CD-SSB, (e) RedCap UE may monitor CORESETO or initial DL BWP for the SIB or paging messages, which may be the cases for non-RedCap UEs with the bandwidth no larger than a maximum bandwidth of RedCap UEs.

In some cases, the UE 115 may be an LTE MTC wireless device. For MTC with limited bandwidth, the UE 115 may receive paging messages based on paging occasions in a time domain and paging narrow-bands in frequency domain. The paging occasion (PO) may refer to the subframe of the start of multiple physical downlink control channel (MPDCCH) repetitions associated with paging radio network temporary identifier (P-RNTI) with PO index i_s=floor (UE_ID/N) mod Ns within the paging frame (PF) at SFN mod T=(T div N)*(UE_ID mod N). The paging narrowband (PNB) may be one narrowband, in which the UE performs paging message reception. The PNB may be determined as a function of UE identifier (ID) and quantity of narrowbands for paging (configured in system information), where PNB=floor (UE_ID/(N*Ns)) mod Nn, with Ns=max (1,nB/T), with Nn being a quantity of paging narrowbands and nB being 4T, 2T, T, T/2, T/4, T/8, T/16, T/32, T/64, T/128, and T/256 with default paging cycle T, used to calculate quantity of paging frames N=min (T,nB) and position of PO i_s and if nB>T, quantity of POs per PF may be determined as Ns=max (1,nB/T). In some cases, the paging may be on a different coverage level. The repetition level for paging monitoring (e.g., 4 repetition levels) may be independent of the narrowband and may be selected by the UE as per the selection or reselection procedures. The maximum repetition level (up to 256) may be signaled in MTC_SIB. The UE 115 may decide to monitor a subset of the repetition levels based on current reference signal received power (RSRP) or current reference signal received quality (RSRQ) measurement. Paging request from the mobility management entity (MME) for a UE may contain enhanced connectivity (EC) level related information and corresponding cell ID (e.g., from UE control element (CE) history stored at the MME).

In some cases, the UE 115 may be an LTE narrowband IoT (LTE NB-IoT) wireless device. For NB-IoT with one physical resource block (PRB) bandwidth, the UE may receive paging messages based on paging occasions in time domain and anchor and non-anchor carriers in frequency domain. The PO may refer to the subframe of the start of NPDCCH repetitions associated with P-RNTI with PO index i_s=floor (UE_ID/N) mod Ns within the paging frame (PF) at SFN mod T=(T div N)*(UE_ID mod N). The paging carrier may be one paging carrier in which the UE performs paging message reception. The paging carrier may be determined as a function of UE_ID, and weighting parameter per carrier (configured in system information) with floor (UE_ID/(N*Ns)) mod W<W (0)+W (1)+ . . . +W (n), with smallest carrier index n, n= [0,Nn), Nn quantity of paging carriers and nB may be 4T, 2T, T, T/2, T/4, T/8, T/16, T/32, T/64, T/128, T/256, T/512, T/1024 with default paging cycle T, used to calculate the quantity of paging frames N=min (T,nB) and position of PO i_s, where if nB>T, the quantity of POs may be determined per PF Ns=max (1,nB/T). In some cases, the paging may be on a different coverage level. The repetition level for paging monitoring may be independent of the carriers and may be selected by the UE as per its selection or reselection procedures. The maximum repetition level (up to 2048) may be signaled in NB_SIB. The UE may decide to monitor a subset of the repetition levels based on current RSRP or RSRQ measurement.

In some cases, a general framework for low complexity IoT devices may be based on the NB-IoT or MTC wireless devices or the RedCap wireless devices. For example, the general framework with respect to the NB-IoT or MTC wireless devices may be a new RAT optimized for the low complexity IoT devices with specific optimizations and channels. In some cases, the general framework with respect to the RedCap devices may be a single RAT with common design addressing different device capabilities. The framework may remove some functionality associated with eMMB UEs with little or no coverage extension. The framework may have limited flexibility to reduce RF bandwidth due to the design of legacy signals, and the framework may minimize infra mobile network operator (MNO) updates to support the low complexity IoT devices.

In some wireless communications systems, the network entity 105 may communicate with a variety of UEs 115, such as an eMBB UE, an IoT UE, a low complexity IoT device, a Redcap wireless device, an eRedCap wireless device, an LTE MTC wireless device, and an LTE NB-IoT) wireless device. In some examples, the network entity 105 may support a LPWA wireless communication technology to support the IoT wireless devices. The LPWA wireless devices (e.g., LPWA UEs) and the eMBB UEs (non-LPWA UEs) may share the same RAT. The network entity 105 may transmit paging messages to the variety of UEs 115. The paging message may be transmitted through scheduled transmissions on allocated resources (e.g., paging occasions) to inform an idle UE 115 to wake up and monitor for information. In some cases, the network entity 105 may support a large quantity of IoT UEs or LPWA UEs and a large quantity of eMBB UEs or non-LPPA UEs, and the network entity 105 may support a large quantity of paging messages to the wireless devices. If the IoT UEs and the eMBB UEs share frequency resources for the paging messages, the IoT UEs and the eMBB UEs may be frequently waken by detecting frequent paging PDCCH and PDSCH to monitor for a paging messages on the shared frequency resources.

Techniques for paging configuration may be employed. In some examples, separate paging BWPs may be configured for a first device type (e.g., LPWA UEs) and a second device type (e.g., non-LPWA UEs). For example, the UE 115 may receive configuration information that indicates one or more first paging BWPs associated with the first device type and one or more second paging BWPs associated with a second device type. The UE 115 may monitor for a paging message associated with the one or more first paging BWPs or the one or more second BWPs based on a device type of the UE, and the device type may be based on device capabilities. In some cases, separate PDCCH monitoring configurations may be configured for the first device type and the second device type. Separate synchronization signals may be configured in the paging BWP for first device type and the second device type. Separate WUS configurations or separate PEI configurations may be configured in the paging BWP for the first device type and the second device type. A same or different paging duty cycle may be configured for the first device type and the second device type. A paging DCI format may be different for first device type as compared to the paging DCI of the second device type.

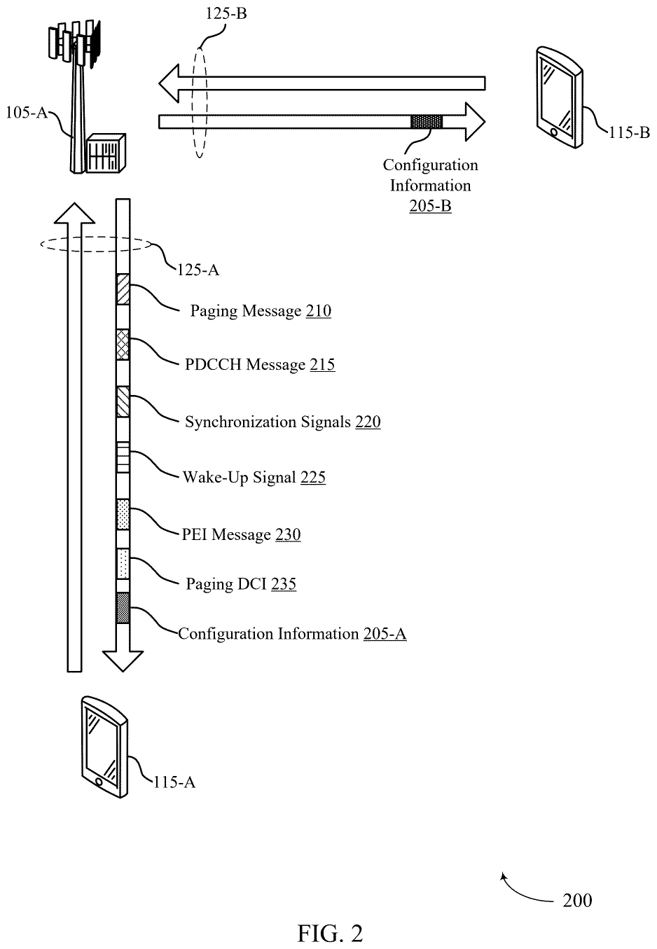

FIG. 2 shows an example of a wireless communications system 200 that supports techniques for paging configuration in accordance with one or more aspects of the present disclosure. The wireless communications system 200 may implement or may be implemented by aspects of the wireless communications system 100. For example, the wireless communications system 200 may include a UE 115-a and a UE 115-b, which may be an example of a UE 115 as described herein. The wireless communications system 200 may include a network entity 105-a, which may be an example of a network entity 105 as described herein.

In some examples, the UE 115-a may be a LPWA UE or first device type, and the UE 115-a may communicate with the network entity 105-a using a communication link 125-a. The communication link 125-a may be an example of a 6th generation (6G), a NR or LTE link between the UE 115-a and the network entity 105-a. The communication link 125-a may include a bi-directional link that enable both uplink and downlink communications. For example, the UE 115-a may transmit uplink signals (e.g., uplink transmissions), such as uplink reference signals, uplink control signals or uplink data signals, to the network entity 105-a using the communication link 125-a and the network entity 105-a may transmit downlink signals (e.g., downlink transmissions), such as downlink reference signals, downlink control signals or downlink data signals, to the UE 115-a using the communication link 125-a.

In some examples, the UE 115-b may be a non-LPWA UE or second device type, and the UE 115-b may communicate with the network entity 105-a using a communication link 125-b. The communication link 125-b may be an example of a 6th generation (6G), a NR or LTE link between the UE 115-b and the network entity 105-a. The communication link 125-b may include a bi-directional link that enable both uplink and downlink communications. For example, the UE 115-b may transmit uplink signals (e.g., uplink transmissions), such as uplink reference signals, uplink control signals or uplink data signals, to the network entity 105-a using the communication link 125-b and the network entity 105-a may transmit downlink signals (e.g., downlink transmissions), such as downlink reference signals, downlink control signals or downlink data signals, to the UE 115-b using the communication link 125-b.

In some examples, the network entity 105-a may transmit to the UEs (e.g., UE 115-a and UE 115-b) configuration information 205-a and configuration information 205-b. The UE 115-a may receive, from the network entity 105-a, the configuration information 205-a, and the UE 115-b may receive, from the network entity 105-a, the configuration information 205-a. In some cases, the configuration information (e.g., configuration information 205-a and configuration information 205-b) may be transmitted in one or more messages.

In some cases, the configuration information may indicate one or more first paging BWPs associated with the first device type and one or more second paging BWPs associated with the second device type. In some cases, the configuration information may include a SIB, a PDCCH monitoring configuration, a PDCCH repetition number, a synchronization signals configuration, a WUS configuration, a PEI configuration, or a paging duty cycle configuration. The UE 115-a may monitor for a paging message 210, a PDCCH message 215, synchronization signals 220, a WUS 225, or a PEI message 230 based on the configuration information 205-a. The UE 115-b may monitor for a paging message, a PDCCH message, synchronization signals, a WUS, or a PEI message based on the configuration information 205-b. In some cases, the UE 115-a may receive an LPWA paging DCI 235.

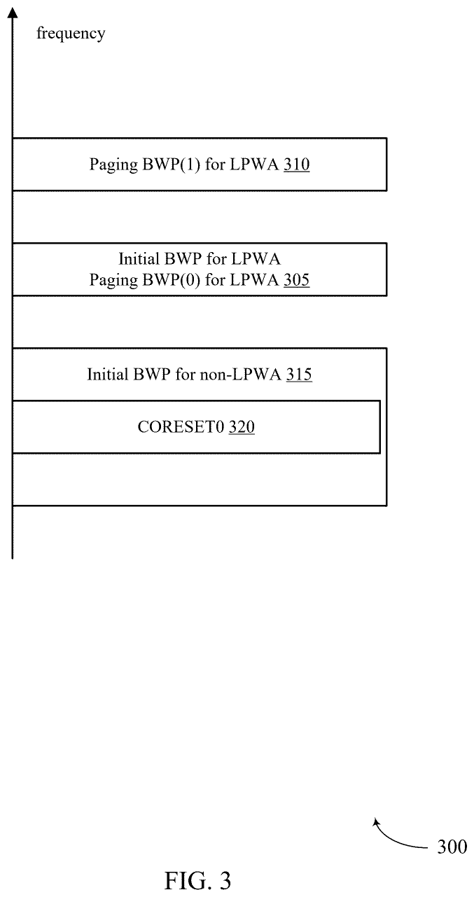

FIG. 3 shows an example of a frequency diagram 300 that supports techniques for paging configuration in accordance with one or more aspects of the present disclosure. The frequency diagram 300 illustrates a frequency resource allocation for paging. The frequency diagram 300 may implement or be implemented by one or more aspects described with reference to FIGS. 1 and 2. For example, the network entity 105-a may configure the UE 115-a and UE 115-b with the frequency resources for paging as shown by the frequency diagram 300.

In some cases, a separate paging BWP may be configured for the first device type (e.g., LPWA UEs) and the second device type (e.g., non-LPWA UEs). For LPWA UEs, one or multiple paging BWPs (e.g., a paging BWP (0) for LPWA 305 and a paging BWP (1) for LPWA 310) may be configured separate from an initial BWP for non-LPWA 315. The paging BWP of the LPWA UE may be determined as a function of UE ID and a total quantity of paging BWPs, and a weighting factor for paging BWP selection may be applied for load balancing. In some examples, the UE (e.g., UE 115-a or UE 115-b) may receive configuration information that indicates one or more first paging BWPs associated with a first device type and one or more second paging BWPs associated with a second device type. The UE may monitor for a paging message associated with the one or more first paging BWPs or the one or more second BWPs based on a device type of the UE, where the device type may be based on device capabilities.

In some examples, a SIB may configure one initial BWP for LPWA UEs that may be used for initial access and for paging of the LPWA UEs. The additional paging BWPs for LPWA UEs may be configured for LPWA UEs. For example, the UE may receive a SIB that indicates an initial BWP used as one paging BWP and additional configuration of the one or more first paging BWPs associated with the first device type. In some cases, a SIB may configure one or multiple initial BWPs for the LPWA UEs, and each BWP may be used for initial access and for paging of LPWA UEs. If not configured, the same initial downlink BWP for paging may be used for the eMBB UEs (e.g., non-LPWA UEs) and the LPWA UEs. For example, the UE may receive a SIB that indicates one or more initial BWPs used as the one or more first paging BWPs associated with the first device type. For eMBB UEs (e.g., non-LPWA UEs) CORESETO 320 or initial DL BWP may be used for paging, SIB, and initial access.

In some cases, a separate PDCCH monitoring configurations may be configured for the first device type (e.g., LPWA UEs) and the second device type (e.g., non-LPWA UEs or eMBB UEs). PDCCH monitoring configurations, such as PDCCH repetitions, pagingSearchSpace, aggregation level (AL) restriction, or CORESET may be separately configured for LPWA UEs. For example, a pagingSearchSpace may be configured in the paging BWP(s) for LPWA UEs, and the paging BWP(s) may not include cell-defining SSB (CD-SSB)/CORESETO. In some cases, different configurations may be supported for LPWA UEs with different coverage levels. For example, the UE may receive a first PDCCH monitoring configuration associated with the first device type or a second PDCCH monitoring configuration associated with the device type. The UE may monitor for a PDCCH message associated with the first PDCCH monitoring configuration or the second PDCCH monitoring configuration based on the device type of the UE.

If the separate PDCCH monitoring configuration is not configured for LPWA UEs, the PDCCH monitoring configuration for LPWA UEs may be based on PDCCH monitoring configuration configured for eMBB UEs broadcasted in SIB, the PDCCH monitoring configuration configured for LPWA UEs with lowest coverage level, or a predefined default value. For example, the UE may receive a PDCCH monitoring configuration associated with the second device type, and the UE may monitor for a PDCCH message associated with the PDCCH monitoring configuration or associated with a lowest coverage level of the PDCCH monitoring configuration, where the device type of the UE is the first device type.

In some cases, the UE (e.g., UE 115-a and UE 115-b) may determine the PDCCH, physical downlink shared channel (PDSCH), or physical uplink shared channel (PUSCH) repetition for paging, such as an associated coverage level for paging PDSCH or PUSCH considering PDCCH repetition. The PDCCH repetition number may be used to indicate the repetition candidates of PDSCH. For example, X repetitions for PDCCH corresponds to up to Y repetition candidates for PDSCH for paging and potentially applicable to other broadcast signals. The UE may receive the PDCCH repetition number associated with a device type, and the UE may determine the PDSCH repetition number or the PUSCH repetition number based on the PDCCH repetition number, where the PDSCH or PUSCH may be scheduled by the PDCCH for the same device type of the UE. Among the repetition candidates, a time domain resource allocation (TDRA) entry may indicate the repetition number for PDSCH or PUSCH. Table I illustrates the repetition candidates.

TABLE I

| | PDCCH | PDSCH/PUSCH |
|---|---|---|
| In DCI | Repetitions | Repetition Candidates |
| 0 | Xₘₐₓ/8 | 1, 2, . . . , Yₘₐₓ/8 |
| 1 | Xₘₐₓ/4 | 1, 2, . . . , Yₘₐₓ/4 |
| 2 | Xₘₐₓ/2 | 1, 2, . . . , Yₘₐₓ/2 |
| 3 | Xₘₐₓ | 1, 2, . . . , Yₘₐₓ |

In some cases, separate synchronization signals may be configured in the paging BWP of the first device type (e.g., LPWA UEs) and the second device type (e.g., non-LPWA UEs or eMBB UEs). For LPWA UEs monitoring a paging-BWP not confining the CD-SSB/CORESETO, one non cell defining SSB (NCD-SSB) or other synchronization signals (e.g., a tracking reference signals (TRS)) may be configured in the paging BWP. The LPWA UEs may not switch to CD-SSB/CORESETO for synchronization before paging monitoring. For example, the UE may receive a first synchronization signal configuration associated with the first device type or a second synchronization signal configuration associated with the second device type. The first synchronization signal configuration may indicate a one or more first synchronization signals associated with the one or more first paging BWPs, and the second synchronization signal configuration may indicate one or more second synchronization signals associated with the one or more second paging BWPs. The UE may monitor for the one or more first synchronization signals or the one or more second synchronization signals based on the device type of the UE.

In some examples, the NCD-SSB may be quasi co-located (QCL-ed) with the CD-SSB with the same SSB index. The NCD-SSB power (energy per resource element (EPRE)) may be the same or different from CD-SSB power, which may be scaled based on the paging coverage level. For 5G NR, the NCD-SSB and the CD-SSB have the same power. The time offset and periodicity of NCD-SSB may be the same or different from CD-SSB, which may be based on the paging duty cycle and paging occasions. Long periodicity for NCD-SSB or other synchronization signals with bursty transmission may have similar or smaller overhead. The NCD-SSB availability may be indicated in the paging PDCCH, similar as TRS availability indication in the flag bits of the PDCCH associated with P-RNTI. The NCD-SSB and TRS availability may be separate or jointly indicated in the flag bits of the PDCCH associated with P-RNTI.

In some cases, separate WUS or PEI may be configured in the paging BWP of the first device type (e.g., LPWA UEs) and the second device type (e.g., non-LPWA UEs or eMBB UEs). The WUS grouping for LPWA UEs may be separate from that of non-LPWA UEs. If one BWP is configured for LPWA UEs and non-LPWA UEs, separate WUS groups for LPWA and non-LPWA UEs may be defined. The shared BWP may be restricted by maximum BW of LPWA UEs, and the PDCCH in the common search space (CSS) for SIB and paging may be time-division multiplexed (TDMed) for LPWA UEs to monitor SIB and paging in different BWPs. For example, the UE may receive a WUS configuration with a first WUS group associated with the first device type or a second WUS group associated with the second device type. The UE may monitor for one or more first WUS associated with the first WUS group or one or more second WUS associated the second WUS group based on the device type of the UE.

In some cases, if a separate BWP is configured for LPWA and non-LPWA UEs, the WUS on each BWP is for LPWA or non-LPWA UEs. The BWP for eMBB UEs may not be restricted by the maximum BW of LPWA UEs, and the CSS for SIB and paging may be TDMed for LPWA UEs to monitor SIB and paging in different BWPs. For example, the UE may receive a first WUS configuration associated with the one or more first paging BWPs and a second WUS configuration associated the one or more second paging BWPs. The UE may monitor one or more first WUS associated with the first WUS configuration or one or more second WUS associated the second WUS configuration based at least in part on the device type of the UE.

For LPWA UEs monitoring a paging BWP, WUS may be configured in all or a subset of paging BWPs. A list of paging BWPs may be configured to support WUS. The paging BWP that supports WUS may carry the WUS in the same BWP. The UEs supporting WUS may monitor the paging BWP that supports WUS. For LPWA UEs, the WUS grouping may be based on the weighting factor for the paging BWP selection. The WUS may be QCL-ed with the NCD-SSB in the same paging BWP.

In some cases, a same paging duty cycle or a different paging duty cycle may be configured for the first device type (e.g., LPWA UEs) and the second device type (e.g., non-LPWA UEs or eMBB UEs). eMBB UEs may use the shortest of UE-specific discontinuous reception (DRX) value and a default DRX value. LPWA UEs may use a default DRX value that is separately configured in SIB. For example, the UE may receive a first paging duty cycle configuration associated with the first device type or a second paging duty cycle configuration associated with the second device type. The UE may monitor for the paging message based on the first paging duty cycle configuration or the second paging duty cycle configuration based on the device type of the UE.

In some examples, if not configured, the paging duty cycle for LPWA UEs may be a similar scheme as for eMBB UEs, a similar scheme for LPWA UEs with lowest coverage level, or a predefined default value. The LPWA UEs may determine the configuration for eMBB UEs via the SIB. For example, the UE may receive the paging duty cycle configuration associated with the second device type, and the UE may monitor for paging message associated with the paging duty cycle configuration or associated with a lowest coverage level of the paging duty cycle configuration, where the device type of the UE is the first device type. In some cases, the LTE MTC UEs may have separate MTC-SIB and may not know the configurations for non-MTC UEs.

In some cases, the paging DCI fields or DCI formats may be different for eMMB UEs and LPWA UEs. The paging DCI fields or DCI formats in the paging BWP may be dedicated for LPWA UEs, with potentially more compact size of the DCI format or more reserved bits in the DCI fields with the same DCI format than the paging DCI format of eMBB UEs. For example, the UE 115-a may receive a first paging DCI in the one or more first paging BWPs associated with the first device type, and the first paging DCI having a first field/format different from a second field/format of a second paging DCI associated with the second device type. The first field/format may include one or more flag bits indicating a paging indication or a direction indications of a short message. The first field/format may include a short message that directly indicates an identification for different system information variations. The short message may be extended to enable direct indication of SIB updates without the UE detecting system information (SI) modification for SIB updates. The short message may directly indicate the SIB version index, which is used as an identification for different system information variations. The different SIB versions may be configured for the UE when the UE initially accesses the network and may be memorized by the UE when the UE monitors the paging message. The existing 2 bits for systemInfoModication (-eDRX) may be used to indicate up to 4 entries, where 2 entries may be used to indicate the SIBx version index in addition to systemInfoModication (-eDRX) as illustrated by Table II. More entries may be used to indicate more SIBx versions by using reserved bits.

TABLE II

| Flag bits | NR Paging/Short Message |
|---|---|
| 00 | Reserved |
| 01 | Only scheduling information for Paging, and TRS availability indication |
| | if trs-ResourceSetConfig is configured, are present in the DCI |
| 10 | Only short message, and TRS availability indication if trs- |
| | ResourceSetConfig is configured, are present in the DCI |
| 11 | Both scheduling information for Paging, TRS availability indication (if |
| | trs-ResourceSetConfig is configured) and short message are present in |
| | the DCI |

| Bit | NR Short Message |
|---|---|
| 1 | systemInfoModification |
| 2 | etwsAndCmasIndication |
| 3 | stopPagingMonitoring |
| 4 | systemInfoModification-eDRX (only to UEs |
| | using IDLE eDRX cycle longer than the |
| | BCCH modification period) |
| 5-8 | Reserved |

Defined 2-bit Entries

| Bits | Entries |
|---|---|
| 00 | systemInfoModification |
| 01 | systemInfoModification-eDRX |
| 10 | SIBx version index 0 |
| 11 | SIBx version index 1 |

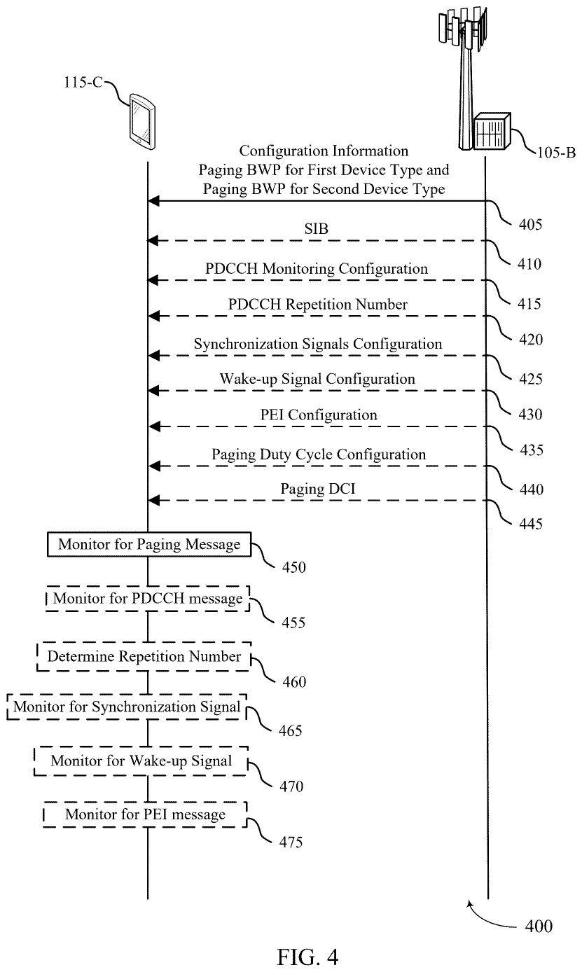

FIG. 4 shows an example of a process flow 400 that supports techniques for paging configuration in accordance with one or more aspects of the present disclosure. The process flow 400 may implement or may be implemented by aspects of the wireless communications system 100 and the wireless communications system 200. For example, the process flow 400 may include a UE 115-c and a network entity 105-b which may be examples of corresponding devices and entities as described with reference to FIGS. 1 and 2. In the following description of the process flow 400, the operations between the UE 115-c and the network entity 105-b may be transmitted in a different order than the example order shown, or the operations performed by the UE 115-c and the network entity 105-b may be performed in different orders or at different times. Some operations may also be omitted from the process flow 400, and other operations may be added to the process flow 400.

At 405, the UE 115-c may receive, from the network entity 105-b, configuration information that indicates one or more first paging BWPs associated with a first device type (e.g., LPWA device) and one or more second paging BWPs associated with a second device type (e.g., non-LPWA device).

At 410, the UE 115-c may receive, from the network entity 105-b, a SIB that indicates an initial BWP used as one paging BWP and additional configuration of the one or more first paging BWPs associated with the first device type. In some cases, the UE 115-c may receive, from the network entity 105-b, a SIB that indicates one or more initial BWPs used as of the one or more first paging BWPs associated with the first device type.

At 415, the UE 115-c may receive, from the network entity 105-b, a first PDCCH monitoring configuration associated with the first device type, a second PDCCH monitoring configuration associated with the second device type, or a combination thereof. In some cases, the UE 115-c may receive, from the network entity 105-b, a PDCCH monitoring configuration associated with the second device type.

At 420, the UE 115-c may receive, from the network entity 105-b, a PDCCH repetition number associated with a device type.

At 425, the UE 115-c may receive, from the network entity 105-b, a first synchronization signal configuration associated with the first device type, a second synchronization signal configuration associated with the second device type, or a combination thereof. The first synchronization signal configuration may indicate one or more first synchronization signals associated with the one or more first paging BWPs and the second synchronization signal configuration indicates one or more second synchronization signals associated with the one or more second paging BWPs.

At 430, the UE 115-c may receive, from the network entity 105-b, a wake-up signal configuration with a first wake-up signal group associated with the first device type, a second wake-up signal group associated with the second device type, or a combination thereof. In some cases, the UE 115-c may receive, from the network entity 105-b, a first wake-up signal configuration associated with the one or more first paging BWPs and a second wake-up signal configuration associated the one or more second paging BWPs.

At 435, the UE 115-c may receive, from the network entity 105-b, a PEI configuration with first PEI messages associated with the first device type, second PEI messages associated with the second device type, or a combination thereof. In some cases, the UE 115-c may receive, from the network entity 105-b, a first PEI configuration associated with the one or more first paging BWPs and a second PEI configuration associated the one or more second paging BWPs.

At 440, the UE 115-c may receive, from the network entity 105-b, a first paging duty cycle configuration associated with the first device type, a second paging duty cycle configuration associated with the second device type, or a combination thereof. In some cases, the UE 115-c may receive, from the network entity 105-b, paging duty cycle configuration associated with the second device type.

At 445, the UE 115-c may receive, from the network entity 105-b, a first paging DCI in the one or more first paging BWPs associated with the first device type, wherein the first paging DCI having a first format different from a second format of a second paging DCI associated with the second device type. In some cases, the first format may include one or more flag bits indicating a paging indication, a direction indications of a short message, or a combination thereof. In some examples, the first format may include a short message that directly indicates an identification for different system information variations.

At 445, the UE 115-c may monitor for a paging message associated with the one or more first paging BWPs or the one or more second BWPs based on a device type of the UE, where the device type is based on device capabilities. In some cases, the UE 115-c may monitor for the paging message based on the first paging duty cycle configuration or the second paging duty cycle configuration based on the device type of the UE. In some cases, the UE 115-c may monitor the paging message associated with the paging duty cycle configuration or associated with a lowest coverage level of the paging duty cycle configuration, where the device type of the UE is the first device type.

At 450, the UE 115-c may monitor for a PDCCH message associated with the first PDCCH monitoring configuration or the second PDCCH monitoring configuration based on the device type of the UE.

At 455, the UE 115-c may monitor for a PDCCH message associated with the PDCCH monitoring configuration or associated with a lowest coverage level of the PDCCH monitoring configuration, wherein the device type of the UE is the first device type.

At 460, the UE 115-c may determine a PDSCH repetition number or a PUSCH repetition number based on the PDCCH repetition number, where a PDSCH or a PUSCH is scheduled by the PDCCH for the same device type of the UE.

At 465, the UE 115-c may monitor for the one or more first synchronization signals associated with the first synchronization signal configuration or the one or more second synchronization signals associated the second synchronization signal configuration based on the device type of the UE.

At 470, the UE 115-c may monitor for one or more wake-up signals associated with the first wake-up signal group or the second wake-up signal group based on the device type of the UE. In some cases, the UE 115-c may monitor for one or more first wake-up signals associated with the first wake-up signal configuration or one or more second wake-up signal signals associated the second wake-up signal configuration based on the device type of the UE.

At 475, the UE 115-c may monitor for one or more first PEI messages associated with the first PEI configuration or one or more second PEI messages associated the second PEI configuration based on the device type of the UE. In some cases, the UE 115-c may monitor for one or more first PEI messages associated with the first PEI configuration or one or more second PEI messages associated the second PEI configuration based on the device type of the UE.

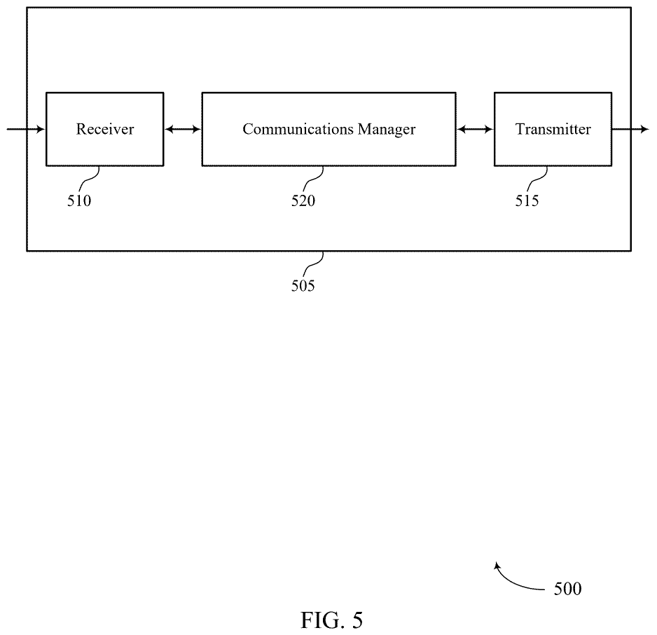

FIG. 5 shows a block diagram 500 of a device 505 that supports techniques for paging configuration in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for paging configuration). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for paging configuration). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for paging configuration as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving configuration information that indicates one or more first paging bandwidth parts (BWPs) associated with a first device type and one or more second paging BWPs associated with a second device type. The communications manager 520 is capable of, configured to, or operable to support a means for monitoring for a paging message associated with the one or more first paging BWPs or the one or more second paging BWPs based on a device type of the UE, where the device type is based on device capabilities.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

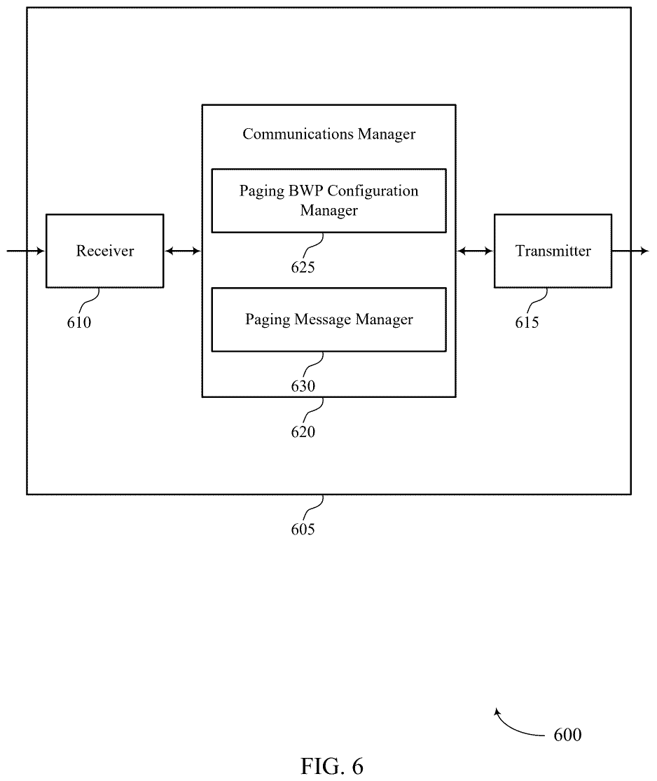

FIG. 6 shows a block diagram 600 of a device 605 that supports techniques for paging configuration in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for paging configuration). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for paging configuration). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for paging configuration as described herein. For example, the communications manager 620 may include a paging BWP configuration manager 625 a paging message manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The paging BWP configuration manager 625 is capable of, configured to, or operable to support a means for receiving configuration information that indicates one or more first paging BWPs associated with a first device type and one or more second paging BWPs associated with a second device type. The paging message manager 630 is capable of, configured to, or operable to support a means for monitoring for a paging message associated with the one or more first paging BWPs or the one or more second paging BWPs based on a device type of the UE, where the device type is based on device capabilities.

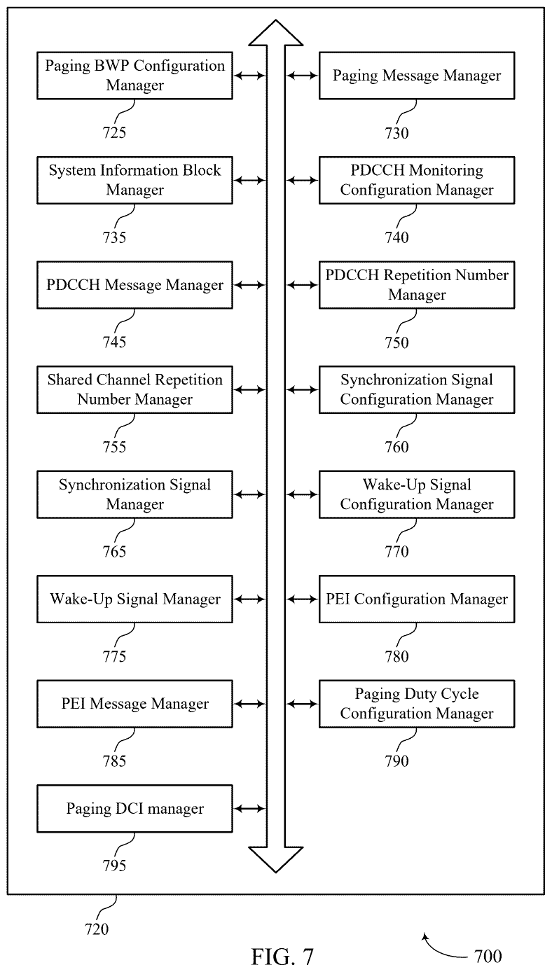

FIG. 7 shows a block diagram 700 of a communications manager 720 that supports techniques for paging configuration in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for paging configuration as described herein. For example, the communications manager 720 may include a paging BWP configuration manager 725, a paging message manager 730, a system information block manager 735, a PDCCH monitoring configuration manager 740, a PDCCH message manager 745, a PDCCH repetition number manager 750, a shared channel repetition number manager 755, a synchronization signal configuration manager 760, a synchronization signal manager 765, a wake-up signal configuration manager 770, a wake-up signal manager 775, a PEI configuration manager 780, a PEI message manager 785, a paging duty cycle configuration manager 790, a paging DCI manager 795, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The paging BWP configuration manager 725 is capable of, configured to, or operable to support a means for receiving configuration information that indicates one or more first BWPs associated with a first device type and one or more second paging BWPs associated with a second device type. The paging message manager 730 is capable of, configured to, or operable to support a means for monitoring for a paging message associated with the one or more first paging BWPs or the one or more second paging BWPs based on a device type of the UE, where the device type is based on device capabilities.

In some examples, to support receiving the configuration information, the system information block manager 735 is capable of, configured to, or operable to support a means for receiving an SIB that indicates an initial BWP used as one paging BWP and additional configuration of the one or more first paging BWPs associated with the first device type.

In some examples, to support receiving the configuration information, the system information block manager 735 is capable of, configured to, or operable to support a means for receiving an SIB that indicates one or more initial BWPs used as the one or more first paging BWPs associated with the first device type.

In some examples, to support receiving the configuration information, the PDCCH monitoring configuration manager 740 is capable of, configured to, or operable to support a means for receiving a first PDCCH monitoring configuration associated with the first device type, a second PDCCH monitoring configuration associated with the second device type, or a combination thereof. In some examples, to support receiving the configuration information, the PDCCH message manager 745 is capable of, configured to, or operable to support a means for monitoring for a PDCCH message associated with the first PDCCH monitoring configuration or the second PDCCH monitoring configuration based on the device type of the UE.

In some examples, to support receiving the configuration information, the PDCCH monitoring configuration manager 740 is capable of, configured to, or operable to support a means for receiving a PDCCH monitoring configuration associated with the second device type. In some examples, to support receiving the configuration information, the PDCCH message manager 745 is capable of, configured to, or operable to support a means for monitoring for a PDCCH message associated with the PDCCH monitoring configuration or associated with a lowest coverage level of the PDCCH monitoring configuration, where the device type of the UE is the first device type.

In some examples, to support receiving the configuration information, the PDCCH repetition number manager 750 is capable of, configured to, or operable to support a means for receiving a PDCCH repetition number associated with a device type. In some examples, to support receiving the configuration information, the shared channel repetition number manager 755 is capable of, configured to, or operable to support a means for determining an PDSCH repetition number or an PUSCH repetition number based on the PDCCH repetition number, where a PDSCH or a PUSCH is scheduled by a PDCCH for a same device type of the UE.

In some examples, to support receiving the configuration information, the synchronization signal configuration manager 760 is capable of, configured to, or operable to support a means for receiving a first synchronization signal configuration associated with the first device type, a second synchronization signal configuration associated with the second device type, or a combination thereof, where the first synchronization signal configuration indicates a one or more first synchronization signals associated with the one or more first paging BWPs and the second synchronization signal configuration indicates a one or more second synchronization signals associated with the one or more second paging BWPs. In some examples, to support receiving the configuration information, the synchronization signal manager 765 is capable of, configured to, or operable to support a means for monitoring for the one or more first synchronization signals associated with the first synchronization signal configuration or the one or more second synchronization signals associated the second synchronization signal configuration based on the device type of the UE.

In some examples, to support receiving the configuration information, the wake-up signal configuration manager 770 is capable of, configured to, or operable to support a means for receiving a wake-up signal configuration with a first wake-up signal group associated with the first device type, a second wake-up signal group associated with the second device type, or a combination thereof. In some examples, to support receiving the configuration information, the wake-up signal manager 775 is capable of, configured to, or operable to support a means for monitoring for one or more wake-up signals associated with the first wake-up signal group or the second wake-up signal group based on the device type of the UE.

In some examples, to support receiving the configuration information, the wake-up signal configuration manager 770 is capable of, configured to, or operable to support a means for receiving a first wake-up signal configuration associated with the one or more first paging BWPs and a second wake-up signal configuration associated the one or more second paging BWPs. In some examples, to support receiving the configuration information, the wake-up signal manager 775 is capable of, configured to, or operable to support a means for monitoring for one or more first wake-up signals associated with the first wake-up signal configuration or one or more second wake-up signal signals associated the second wake-up signal configuration based on the device type of the UE.

In some examples, to support receiving the configuration information, the PEI configuration manager 780 is capable of, configured to, or operable to support a means for receiving a PEI configuration with first PEI messages associated with the first device type, second PEI messages associated with the second device type, or a combination thereof. In some examples, to support receiving the configuration information, the PEI message manager 785 is capable of, configured to, or operable to support a means for monitoring for first PEI messages or the second PEI messages based on the device type of the UE.

In some examples, to support receiving the configuration information, the PEI configuration manager 780 is capable of, configured to, or operable to support a means for receiving a first PEI configuration associated with the one or more first paging BWPs and a second PEI configuration associated the one or more second paging BWPs. In some examples, to support receiving the configuration information, the PEI message manager 785 is capable of, configured to, or operable to support a means for monitoring for one or more first PEI messages associated with the first PEI configuration or one or more second PEI messages associated the second PEI configuration based on the device type of the UE.

In some examples, to support receiving the configuration information, the paging duty cycle configuration manager 790 is capable of, configured to, or operable to support a means for receiving a first paging duty cycle configuration associated with the first device type, a second paging duty cycle configuration associated with the second device type, or a combination thereof. In some examples, to support receiving the configuration information, the paging message manager 730 is capable of, configured to, or operable to support a means for monitoring for the paging message based on the first paging duty cycle configuration or the second paging duty cycle configuration based on the device type of the UE.

In some examples, to support receiving the configuration information, the paging duty cycle configuration manager 790 is capable of, configured to, or operable to support a means for receiving paging duty cycle configuration associated with the second device type. In some examples, to support receiving the configuration information, the paging message manager 730 is capable of, configured to, or operable to support a means for monitoring for the paging message associated with the paging duty cycle configuration or associated with a lowest coverage level of the paging duty cycle configuration, where the device type of the UE is the first device type.

In some examples, the paging DCI manager 795 is capable of, configured to, or operable to support a means for receiving a first paging DCI associated with the first device type, where the first paging DCI having a first format different from a second format of a second paging DCI associated with the second device type.

In some examples, the first format including one or more flag bits indicating a paging indication, a direction indications of a short message, or combination of both.

In some examples, the first format including a short message that directly indicates an identification for different system information variations.

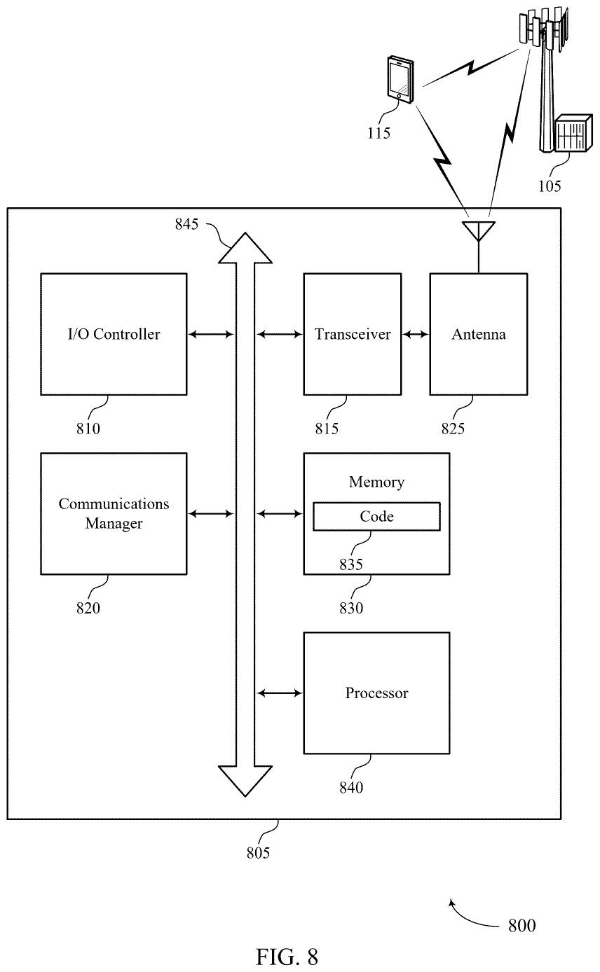

FIG. 8 shows a diagram of a system 800 including a device 805 that supports techniques for paging configuration in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for paging configuration). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving configuration information that indicates one or more first paging BWPs associated with a first device type and one or more second paging BWPs associated with a second device type. The communications manager 820 is capable of, configured to, or operable to support a means for monitoring for a paging message associated with the one or more first paging BWPs or the one or more second paging BWPs based on a device type of the UE, where the device type is based on device capabilities.

By including or configuring the communications manager 820 in accordance with examples as described herein, the device 805 may support techniques for improved communication reliability, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for paging configuration as described herein, or the at least one processor 840 and the at least one memory 830 may be otherwise configured to, individually or collectively, perform or support such operations.

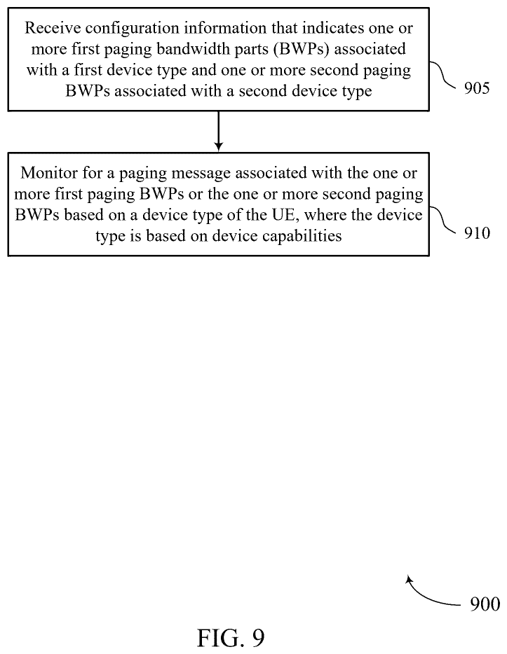

FIG. 9 shows a flowchart illustrating a method 900 that supports techniques for paging configuration in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving configuration information that indicates one or more first paging BWPs associated with a first device type and one or more second paging BWPs associated with a second device type. The operations of 905 may be performed in accordance with examples as disclosed herein. In some examples, aspects of the operations of 905 may be performed by a paging BWP configuration manager 725 as described with reference to FIG. 7.

At 910, the method may include monitoring for a paging message associated with the one or more first paging BWPs or the one or more second paging BWPs based on a device type of the UE, where the device type is based on device capabilities. The operations of 910 may be performed in accordance with examples as disclosed herein. In some examples, aspects of the operations of 910 may be performed by a paging message manager 730 as described with reference to FIG. 7.

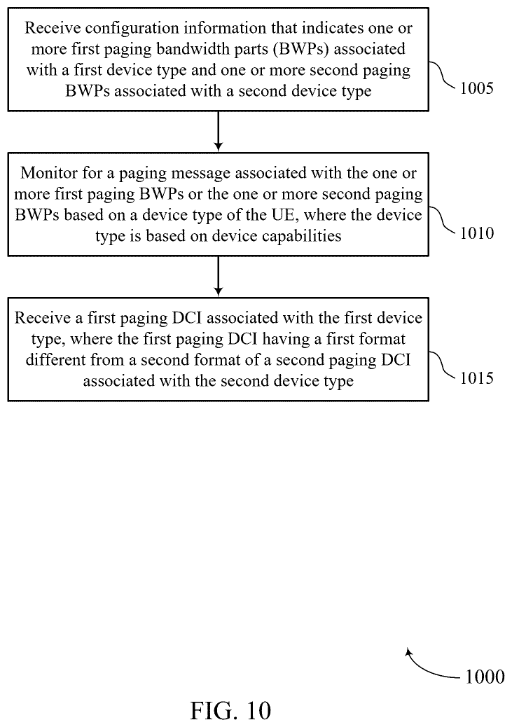

FIG. 10 shows a flowchart illustrating a method 1000 that supports techniques for paging configuration in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving configuration information that indicates one or more first paging BWPs associated with a first device type and one or more second paging BWPs associated with a second device type. The operations of 1005 may be performed in accordance with examples as disclosed herein. In some examples, aspects of the operations of 1005 may be performed by a paging BWP configuration manager 725 as described with reference to FIG. 7.

At 1010, the method may include monitoring for a paging message associated with the one or more first paging BWPs or the one or more second paging BWPs based on a device type of the UE, where the device type is based on device capabilities. The operations of 1010 may be performed in accordance with examples as disclosed herein. In some examples, aspects of the operations of 1010 may be performed by a paging message manager 730 as described with reference to FIG. 7.

At 1015, the method may include receiving a first paging DCI associated with the first device type, where the first paging DCI having a first format different from a second format of a second paging DCI associated with the second device type. The operations of 1015 may be performed in accordance with examples as disclosed herein. In some examples, aspects of the operations of 1015 may be performed by a paging DCI manager 795 as described with reference to FIG. 7.

The following provides an overview of aspects of the present disclosure:

Aspect 1: A method for wireless communications by a UE, comprising: receiving configuration information that indicates one or more first paging BWPs associated with a first device type and one or more second paging BWPs associated with a second device type; and monitoring for a paging message associated with the one or more first paging BWPs or the one or more second paging BWPs based at least in part on a device type of the UE, wherein the device type is based on device capabilities.

Aspect 2: The method of aspect 1, wherein receiving the configuration information further comprises: receiving an SIB that indicates an initial BWP used as one paging BWP and additional configuration of the one or more first paging BWPs associated with the first device type.

Aspect 3: The method of any of aspects 1 through 2, wherein receiving the configuration information further comprises: receiving an SIB that indicates one or more initial BWPs used as the one or more first paging BWPs associated with the first device type.

Aspect 4: The method of any of aspects 1 through 3, wherein receiving the configuration information further comprises: receiving a first PDCCH monitoring configuration associated with the first device type, a second PDCCH monitoring configuration associated with the second device type, or a combination thereof; and monitoring for a PDCCH message associated with the first PDCCH monitoring configuration or the second PDCCH monitoring configuration based at least in part on the device type of the UE.

Aspect 5: The method of any of aspects 1 through 4, wherein receiving the configuration information further comprises: receiving a PDCCH monitoring configuration associated with the second device type; and monitoring for a PDCCH message associated with the PDCCH monitoring configuration or associated with a lowest coverage level of the PDCCH monitoring configuration, wherein the device type of the UE is the first device type.

Aspect 6: The method of any of aspects 1 through 5, wherein receiving the configuration information further comprises: receiving a PDCCH repetition number associated with a device type; and determining an PDSCH repetition number or an PUSCH repetition number based at least in part on the PDCCH repetition number, wherein a PDSCH or a PUSCH is scheduled by a PDCCH for a same device type of the UE.

Aspect 7: The method of any of aspects 1 through 6, wherein receiving the configuration information further comprises: receiving a first synchronization signal configuration associated with the first device type, a second synchronization signal configuration associated with the second device type, or a combination thereof, wherein the first synchronization signal configuration indicates a one or more first synchronization signals associated with the one or more first paging BWPs and the second synchronization signal configuration indicates a one or more second synchronization signals associated with the one or more second paging BWPs; and monitoring for the one or more first synchronization signals associated with the first synchronization signal configuration or the one or more second synchronization signals associated the second synchronization signal configuration based at least in part on the device type of the UE.

Aspect 8: The method of any of aspects 1 through 7, wherein receiving the configuration information further comprises: receiving a wake-up signal configuration with a first wake-up signal group associated with the first device type, a second wake-up signal group associated with the second device type, or a combination thereof; and monitoring for one or more wake-up signals associated with the first wake-up signal group or the second wake-up signal group based at least in part on the device type of the UE.

Aspect 9: The method of any of aspects 1 through 8, wherein receiving the configuration information further comprises: receiving a first wake-up signal configuration associated with the one or more first paging BWPs and a second wake-up signal configuration associated the one or more second paging BWPs; and monitoring for one or more first wake-up signals associated with the first wake-up signal configuration or one or more second wake-up signal signals associated the second wake-up signal configuration based at least in part on the device type of the UE.

Aspect 10: The method of any of aspects 1 through 9, wherein receiving the configuration information further comprises: receiving a PEI configuration with first PEI messages associated with the first device type, second PEI messages associated with the second device type, or a combination thereof; and monitoring for first PEI messages or the second PEI messages based at least in part on the device type of the UE.

Aspect 11: The method of any of aspects 1 through 10, wherein receiving the configuration information further comprises: receiving a first paging early indication (PEI) configuration associated with the one or more first paging BWPs and a second PEI configuration associated the one or more second paging BWPs; and monitoring for one or more first PEI messages associated with the first PEI configuration or one or more second PEI messages associated the second PEI configuration based at least in part on the device type of the UE.

Aspect 12: The method of any of aspects 1 through 11, wherein receiving the configuration information further comprises: receiving a first paging duty cycle configuration associated with the first device type, a second paging duty cycle configuration associated with the second device type, or a combination thereof; and monitoring for the paging message based at least in part on the first paging duty cycle configuration or the second paging duty cycle configuration based at least in part on the device type of the UE.

Aspect 13: The method of any of aspects 1 through 12, wherein receiving the configuration information further comprises: receiving paging duty cycle configuration associated with the second device type; and monitoring for the paging message associated with the paging duty cycle configuration or associated with a lowest coverage level of the paging duty cycle configuration, wherein the device type of the UE is the first device type.

Aspect 14: The method of any of aspects 1 through 13, further comprising: receiving a first paging DCI associated with the first device type, wherein the first paging DCI having a first format different from a second format of a second paging DCI associated with the second device type.

Aspect 15: The method of aspect 14, wherein the first format comprising one or more flag bits indicating a paging indication, a direction indications of a short message, or combination of both.

Aspect 16: The method of any of aspects 14 through 15, wherein the first format comprising a short message that directly indicates an identification for different system information variations.

Aspect 17: A UE for wireless communications, comprising one or more memories storing processor-executable code, and one or more processors coupled with the one or more memories and individually or collectively operable to execute the code to cause the UE to perform a method of any of aspects 1 through 16.

Aspect 18: A UE for wireless communications, comprising at least one means for performing a method of any of aspects 1 through 16.

Aspect 19: A non-transitory computer-readable medium storing code for wireless communications, the code comprising instructions executable by one or more processors to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information that indicates one or more first paging bandwidth parts (BWPs) associated with a first device type and one or more second paging BWPs associated with a second device type; and
monitor for a paging message associated with the one or more first paging BWPs or the one or more second paging BWPs based at least in part on a device type of the UE, wherein the device type is based on device capabilities.

2. The UE of claim 1, wherein, to receive the configuration information, the one or more processors are individually or collectively further operable to execute the code to cause the UE to:
receive a system information block (SIB) that indicates an initial BWP used as one paging BWP and additional configuration of the one or more first paging BWPs associated with the first device type.

3. The UE of claim 1, wherein, to receive the configuration information, the one or more processors are individually or collectively further operable to execute the code to cause the UE to:
receive a system information block (SIB) that indicates one or more initial BWPs used as the one or more first paging BWPs associated with the first device type.

4. The UE of claim 1, wherein, to receive the configuration information, the one or more processors are individually or collectively further operable to execute the code to cause the UE to:
receive a first physical downlink control channel (PDCCH) monitoring configuration associated with the first device type, a second PDCCH monitoring configuration associated with the second device type, or a combination thereof; and
monitor for a PDCCH message associated with the first PDCCH monitoring configuration or the second PDCCH monitoring configuration based at least in part on the device type of the UE.

5. The UE of claim 1, wherein, to receive the configuration information, the one or more processors are individually or collectively further operable to execute the code to cause the UE to:
receive a physical downlink control channel (PDCCH) monitoring configuration associated with the second device type; and
monitor for a PDCCH message associated with the PDCCH monitoring configuration or associated with a lowest coverage level of the PDCCH monitoring configuration, wherein the device type of the UE is the first device type.

6. The UE of claim 1, wherein, to receive the configuration information, the one or more processors are individually or collectively further operable to execute the code to cause the UE to:
receive a physical downlink control channel (PDCCH) repetition number associated with a device type; and
determine a physical downlink shared channel (PDSCH) repetition number or a physical uplink shared channel (PUSCH) repetition number based at least in part on the PDCCH repetition number, wherein a PDSCH or a PUSCH is scheduled by a PDCCH for a same device type of the UE.

7. The UE of claim 1, wherein, to receive the configuration information, the one or more processors are individually or collectively further operable to execute the code to cause the UE to:
receive a first synchronization signal configuration associated with the first device type, a second synchronization signal configuration associated with the second device type, or a combination thereof, wherein the first synchronization signal configuration indicates a one or more first synchronization signals associated with the one or more first paging BWPs and the second synchronization signal configuration indicates a one or more second synchronization signals associated with the one or more second paging BWPs; and
monitor for the one or more first synchronization signals associated with the first synchronization signal configuration or the one or more second synchronization signals associated the second synchronization signal configuration based at least in part on the device type of the UE.

8. The UE of claim 1, wherein, to receive the configuration information, the one or more processors are individually or collectively further operable to execute the code to cause the UE to:
receive a wake-up signal configuration with a first wake-up signal group associated with the first device type, a second wake-up signal group associated with the second device type, or a combination thereof; and
monitor for one or more wake-up signals associated with the first wake-up signal group or the second wake-up signal group based at least in part on the device type of the UE.

9. The UE of claim 1, wherein, to receive the configuration information, the one or more processors are individually or collectively further operable to execute the code to cause the UE to:
receive a first wake-up signal configuration associated with the one or more first paging BWPs and a second wake-up signal configuration associated the one or more second paging BWPs; and
monitor for one or more first wake-up signals associated with the first wake-up signal configuration or one or more second wake-up signal signals associated the second wake-up signal configuration based at least in part on the device type of the UE.

10. The UE of claim 1, wherein, to receive the configuration information, the one or more processors are individually or collectively further operable to execute the code to cause the UE to:
receive a paging early indication (PEI) configuration with first PEI messages associated with the first device type, second PEI messages associated with the second device type, or a combination thereof; and
monitor for the first PEI messages or the second PEI messages based at least in part on the device type of the UE.

11. The UE of claim 1, wherein, to receive the configuration information, the one or more processors are individually or collectively further operable to execute the code to cause the UE to:
receive a first paging early indication (PEI) configuration associated with the one or more first paging BWPs and a second PEI configuration associated the one or more second paging BWPs; and
monitor for one or more first PEI messages associated with the first PEI configuration or one or more second PEI messages associated the second PEI configuration based at least in part on the device type of the UE.

12. The UE of claim 1, wherein, to receive the configuration information, the one or more processors are individually or collectively further operable to execute the code to cause the UE to:
receive a first paging duty cycle configuration associated with the first device type, a second paging duty cycle configuration associated with the second device type, or a combination thereof; and
monitor for the paging message based at least in part on the first paging duty cycle configuration or the second paging duty cycle configuration based at least in part on the device type of the UE.

13. The UE of claim 1, wherein, to receive the configuration information, the one or more processors are individually or collectively further operable to execute the code to cause the UE to:
receive paging duty cycle configuration associated with the second device type; and
monitor for the paging message associated with the paging duty cycle configuration or associated with a lowest coverage level of the paging duty cycle configuration, wherein the device type of the UE is the first device type.

14. The UE of claim 1, wherein the one or more processors are individually or collectively further operable to execute the code to cause the UE to:
receive a first paging downlink control information (DCI) associated with the first device type, wherein the first paging DCI having a first format different from a second format of a second paging DCI associated with the second device type.

15. The UE of claim 14, wherein the first format comprising one or more flag bits indicating a paging indication, a direction indications of a short message, or combination of both.

16. The UE of claim 14, wherein the first format comprising a short message that directly indicates an identification for different system information variations.

17. A method for wireless communications by a user equipment (UE), comprising:
receiving configuration information that indicates one or more first paging bandwidth parts (BWPs) associated with a first device type and one or more second paging BWPs associated with a second device type; and
monitoring for a paging message associated with the one or more first paging BWPs or the one or more second paging BWPs based at least in part on a device type of the UE, wherein the device type is based on device capabilities.

18. The method of claim 17, wherein receiving the configuration information further comprises:
receiving a wake-up signal configuration with a first wake-up signal group associated with the first device type, a second wake-up signal group associated with the second device type, or a combination thereof; and
monitoring for one or more wake-up signals associated with the first wake-up signal group or the second wake-up signal group based at least in part on the device type of the UE.

19. The method of claim 17, wherein receiving the configuration information further comprises:
receiving a paging early indication (PEI) configuration with first PEI messages associated with the first device type, second PEI messages associated with the second device type, or a combination thereof; and
monitoring for the first PEI messages or the second PEI messages based at least in part on the device type of the UE.

20. A non-transitory computer-readable medium storing code for wireless communications, the code comprising instructions executable by one or more processors to:
receive configuration information that indicates one or more first paging bandwidth parts (BWPs) associated with a first device type and one or more second paging BWPs associated with a second device type; and
monitor for a paging message associated with the one or more first paging BWPs or the one or more second paging BWPs based at least in part on a device type of a UE, wherein the device type is based on device capabilities.
